(19) United States
(12) Patent Application Publication
(10) Pub. No.: US 2004/0268294 A1
(43) Pub. Date: Dec. 30, 2004

(54) Network-aided inter-team collaboration

(76) Inventors: Christopher Budd, Bellevue, WA (US); Christopher T. Edwards, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(21) Appl. No.: 10/611,690

(22) Filed: Jun. 30, 2003

(51) Int. Cl. G06F 9/44

(52) U.S. Cl. 717/103

(57) ABSTRACT

A server-implemented mechanism for coordinating communication between various teams in a manner that assists in the generation of corrective software that resolves a software performance deviation. In a broader context, the server coordinates inter-team communication for any other purposes. The server identifies a course of steps that when successfully completed advances the purpose (e.g., development of corrective software). For each of the steps in the course of steps, the server identifies a corresponding team of one or more people responsible for proper implementation of the step. For any given step in the course of steps, the server provides a user interface that at least a representative of the responsible team may access to complete the step. The server also facilitates notification between different teams when the workflow transfers from one team to another. The mechanism also tracks progress and schedules associated with the communications.

### BACKGROUND OF THE INVENTION

1. The Field of the Invention

The present invention relates to software development technology and inter-team communications. More specifically, the present invention relates to a network-aided mechanism for facilitating efficient inter-team cooperation as when correcting software performance deviations.

2. Background and Related Art

Computing technology has transformed the way we work and play. Computing technology relies on sophisticated hardware including interconnected processing, memory, communication and user interface devices. Software governs how these various physical components interact with each other and with a user in order to enable a substantially unlimited variety of applications.

Software is becoming more and more complex as time progresses. It is not at all unusual for an application to contain many thousands, and even millions of discrete binary instructions. Due to such complexity, software products sometimes contain deviations in expected performance often referred to as “bugs” even when the software product has been designed and authored by experienced software engineers, and undergone extensive testing. Accordingly, whether during the testing process, or subsequent to product release, software performance deviations sometimes arise.

Correction of software performance deviations can also be a complex process, requiring a wide range of expertise not typically held by any single individual or even any single team of individuals. Without sufficient inter-team cooperation, correction of the software performance deviation correction can be an inefficient process, thereby wasting resources of the entity charged with making the correction. In addition, sometimes there is urgency in resolving the software performance deviations as quickly as possible, as when, for example, the software performance deviation has an impact on security or privacy.

Accordingly, what would be advantageous is to have an efficient mechanism for implementing the complex processes involved with the correction of software performance deviations. It would be particularly advantageous if the mechanism also tracked time budgets and progress towards correction.

### BRIEF SUMMARY OF THE INVENTION

The foregoing problems with the prior state of the art are overcome by the principles of the present invention which are directed towards a mechanism for a server computing system coordinating communication between a number of client computing systems associated with a number of different teams in a manner that allows the various teams to cooperatively accomplish a specific purpose such as generating corrective software that resolves a software performance deviation.

The server identifies a course of steps that when successfully completed advances the purpose (e.g., advances development of corrective software for a software performance deviation present in a product). The course of steps requires cooperation between a number of different teams. For each of the steps in the course of steps, the server identifies a corresponding team of one or more people responsible for proper implementation of the step.

The course of steps may include serial as well as parallel process flows. For any given step in the course of steps, the server provides a user interface that at least a representative of the responsible team may access to complete the step. Upon completion of that step, the server provides a second user interface that corresponds to the next step and that at least the representative of the team responsible for the next step may access to complete the next step. If the team responsible for the next step is different than the team responsible for the previous step, then the server causes at least a representative of the team responsible for the next step to be notified upon the completion of the previous step. If the team is the same, then the server may cause a notification to occur to the same team, as a reminder.

Accordingly, the server facilitates communication to advance the correction of a software performance deviation, even if steps associated with correcting the deviation require cooperative interaction among multiple teams. The organized and standardized approach to correction of software performance deviations allows for faster and more coherent software correction, with a higher chance that a quality software correction will be issued.

If the purpose is the generation of corrective software for a software performance deviation, the software performance deviation may be present in multiple products, in which case the server may coordinate the course of steps for each product, and for each version of the product. However, the network-aided inter-team collaboration in accordance with the present invention may be used for the accomplishment of any purpose, not just for the correction of a software performance deviation. The server may also coordinate time budgets associated with the various steps in the course of steps and provide reporting regarding the same so that progress in generating the corrective software may be accurately evaluated.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a suitable computing system that may implement the features of the present invention;

FIG. 2 illustrates a network environment in which the principles of the present invention may be employed;

FIG. 3 illustrates a method for facilitating inter-team communication to advance the generation of corrective software for a software performance deviation;

FIG. 4 illustrates an investigation administration user interface that may be used navigate to various investigations, each regarding a software performance deviation;

FIG. 5 illustrates a hierarchical structure of an investigation that encompasses multiple software products;

FIG. 6 illustrates a user interface that summarizes a course of steps involved with advancing the generation of corrective software;

FIG. 7 illustrates a user interface that a first team may access to complete a particular step in the course of steps;

FIG. 8 illustrates a user interface that a second team may access to complete another step in the course of steps;

FIG. 9 illustrates a user interface that may be used to track time budgets as progress is made through the course of steps; and

FIG. 10 illustrates a user interface that may be viewed to track progress associated with generating corrective software.

### DETAILED DESCRIPTION OF THE PREFERRED EMBODIMENTS

The principles of the present invention relate to a mechanism for a server computing system coordinating communication between a number of client computing systems in a manner that assists in the generation of corrective software that resolves a software performance deviation. The server identifies a course of steps that when successfully completed advances development of corrective software for a software performance deviation in a product. For each of the steps in the course of steps, the server identifies a corresponding team of one or more people responsible for proper implementation of the step. For any given step in the course of steps, the server provides a user interface that at least a representative of the responsible team may access to complete the step. The server also facilitates notification between different teams when the workflow transfers from one team to another. The mechanism may be used for any inter-team collaboration regardless of the ultimate purpose, and not just for the correction of a software performance deviation.

Embodiments within the scope of the present invention include computer-readable media for carrying or having computer-executable instructions or data structures stored thereon. Such computer-readable media can be any available media which can be accessed by a general purpose or special purpose computer. By way of example, and not limitation, such computer-readable media can comprise physical computer-readable media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, any instructions and data which cause a general purpose computer, special purpose computer, or special purpose processing device to perform a certain function or group of functions. The computer-executable instruction may be, for example, binaries, intermediate format instructions such as assembly language, or even source code. Although not required, the invention will be described in the general context of computer-executable instructions, such as program modules, being executed by computers in network environments. Generally, program modules include routines, programs, objects, components, data structures, etc. that perform particular tasks or implement particular abstract data types.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

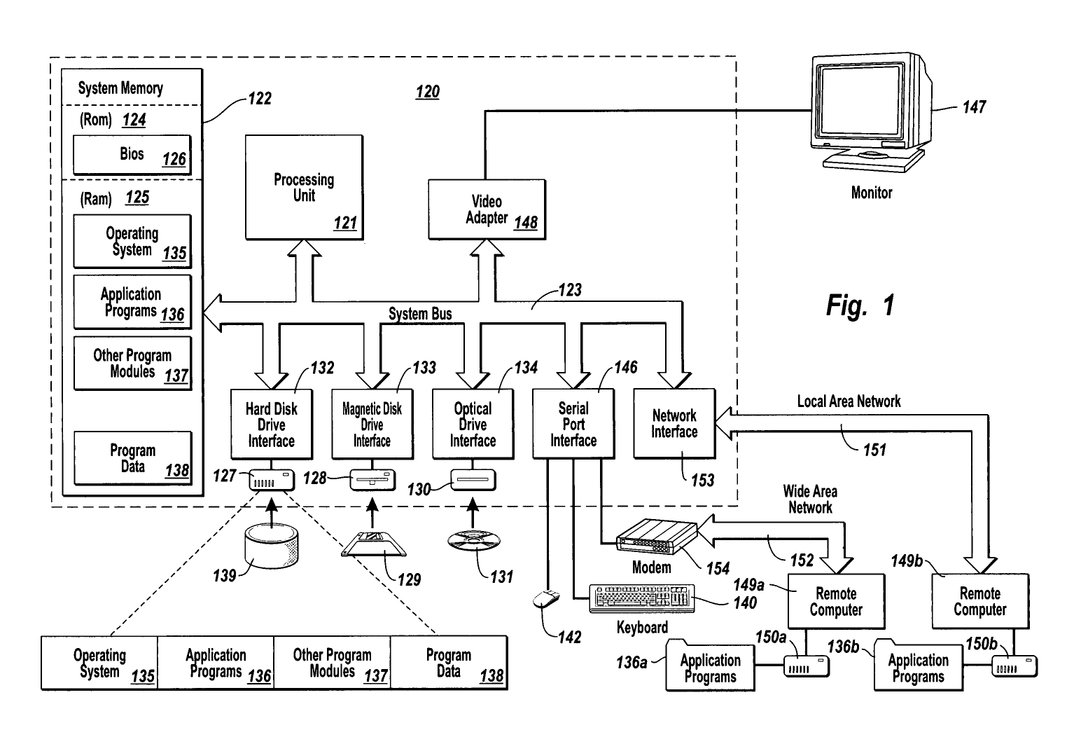

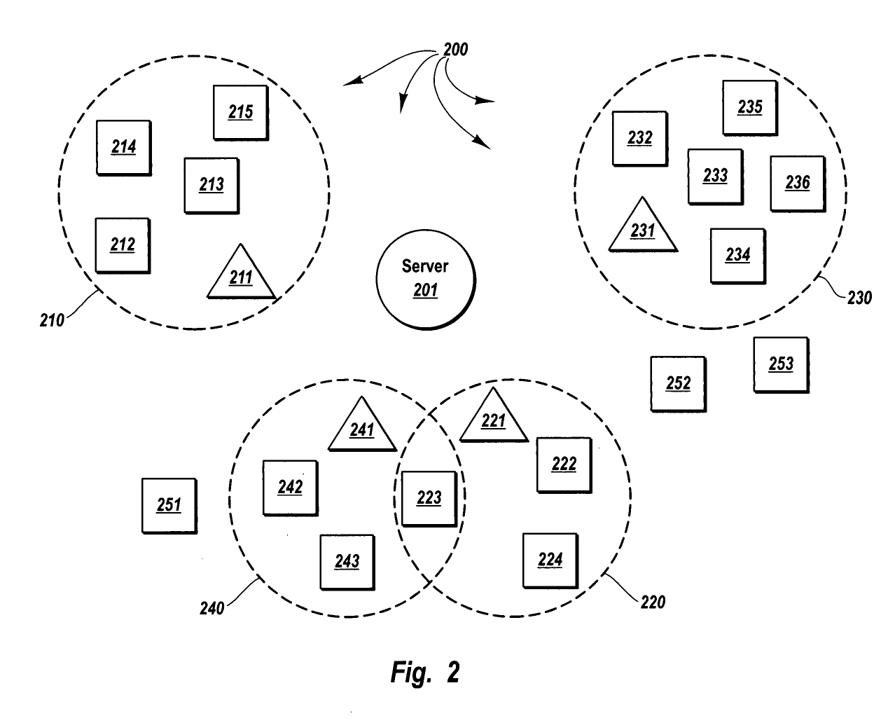

First, a suitable computing system for implementing the features of the present invention will be described with respect to FIG. 1 and Section I below. Then, a specific embodiment of the invention will be described in which the course of steps related to the generation of corrective software for a software performance deviation with respect to FIGS. 2 through 10 and Section II below. Then, a more general embodiment of the invention will be briefly described by extending the principles of the specific embodiment to any course of steps that require inter-team communication with respect to Section III below.

Section I—Suitable Computing Environment

FIG. 1 illustrates suitable computing environment in which the principles of the present invention may be employed in the form of a computer 120. The computer 120 includes a processing unit 121, a system memory 122, and a system bus 123 that couples various system components including the system memory 122 to the processing unit 121.

The system bus 123 may be any of several types of bus structures including a memory bus or memory controller, a peripheral bus, and a local bus using any of a variety of bus architectures. The system memory includes read only memory (ROM) 124 and random access memory (RAM) 125. A basic input/output system (BIOS) 126, containing the basic routines that help transfer information between elements within the computer 120, such as during start-up, may be stored in ROM 124.

The computer 120 may also include a magnetic hard disk drive 127 for reading from and writing to a magnetic hard disk 139, a magnetic disk drive 128 for reading from or writing to a removable magnetic disk 129, and an optical disk drive 130 for reading from or writing to removable optical disk 131 such as a CD-ROM or other optical media. The magnetic hard disk drive 127, magnetic disk drive 128, and optical disk drive 130 are connected to the system bus 123 by a hard disk drive interface 132, a magnetic disk drive-interface 133, and an optical drive interface 134, respectively. The drives and their associated computer-readable media provide nonvolatile storage of computer-executable instructions, data structures, program modules and other data for the computer 120. Although the exemplary environment described herein employs a magnetic hard disk 139, a removable magnetic disk 129 and a removable optical disk 131, other types of computer readable media for storing data can be used, including magnetic cassettes, flash memory cards, digital video disks, Bernoulli cartridges, RAMs, ROMs, and the like.

Program code means comprising one or more program modules may be stored on the hard disk 139, magnetic disk 129, optical disk 131, ROM 124 or RAM 125, including an operating system 135, one or more application programs 136, other program modules 137, and program data 138. A user may enter commands and information into the computer 120 through keyboard 140, pointing device 142, or other input devices (not shown), such as a microphone, joy stick, game pad, satellite dish, scanner, or the like. These and other input devices are often connected to the processing unit 121 through a serial port interface 146 coupled to system bus 123. Alternatively, the input devices may be connected by other interfaces, such as a parallel port, a game port or a universal serial bus (USB). A monitor 147 or another display device is also connected to system bus 123 via an interface, such as video adapter 148. In addition to the monitor, personal computers typically include other peripheral output devices (not shown), such as speakers and printers.

The computer 120 may operate in a networked environment using logical connections to one or more remote computers, such as remote computers 149a and 149b. Remote computers 149a and 149b may each be another personal computer, a server, a router, a network PC, a peer device or other common network node, and typically include many or all of the elements described above relative to the computer 120, although only memory storage devices 150a and 150b and their associated application programs 136a and 136b have been illustrated in FIG. 1. The logical connections depicted in FIG. 1 include a local area network (LAN) 151 and a wide area network (WAN) 152 that are presented here by way of example and not limitation. Such networking environments are commonplace in office-wide or enterprise-wide computer networks, intranets and the Internet.

When used in a LAN networking environment, the computer 120 is connected to the local network 151 through a network interface or adapter 153. When used in a WAN networking environment, the computer 120 may include a modem 154, a wireless link, or other means for establishing communications over the wide area network 152, such as the Internet. The modem 154, which may be internal or external, is connected to the system bus 123 via the serial port interface 146. In a networked environment, program modules depicted relative to the computer 120, or portions thereof, may be stored in the remote memory storage device. It will be appreciated that the network connections shown are exemplary and other means of establishing communications over wide area network 152 may be used.

While FIG. 1 represents a suitable operating environment for the present invention, the principles of the present invention may be employed in any computing system that is capable of sending network messages and otherwise performing the principles of the present invention. The computing system illustrated in FIG. 1 is illustrative only, and by no means represents even a small portion of the wide variety of environments in which the principles of the present invention may be implemented. In the description and in the claims, a “computing system” is defined broadly as any hardware component or components that are capable of using software to perform one or more functions. Examples of computing systems include desktop computers, laptop computers, Personal Digital Assistants (PDAs), telephones, or any other system or device that has processing capability.

Section II—Specific Embodiment Related to Software Performance Deviation Correction

FIG. 2 illustrates a network environment 200 in which the principles of the present invention may be employed. The network environment 200 includes a server computing system 201 (hereinafter also referred to as simply a “server”) and multiple client computing systems (each hereinafter also referred to as simply a “client”). There may be any number of clients in the network, each having an associated user that belongs to one or more teams, each responsible for certain aspects of generating the corrective software.

For example, as illustrated in FIG. 2, the network environment 200 has clients that have associated users belonging to teams 210, 220, 230 and 240 among potentially other clients that do not belong to any of teams 210, 220, 230 or 240. As illustrated, clients 211 through 215 each have a user that belongs to the team 210; clients 221 through 224 each have a user that belongs to the team 220; clients 231 through 236 each have a user that belongs to the team 230; and clients 241 through 243 and 223 each have a user that belongs to the team 240. Other clients 251 through 253 may also be present in the network environment, but not belong to any of teams 210 through 240. In addition, some clients may be members of multiple teams. For example, client 223 belongs to both teams 220 and 240. The server 201 and clients may each be structured as illustrated and described above with respect to the computer 120 of FIG. 1, although (as previously mentioned) this is by no means required.

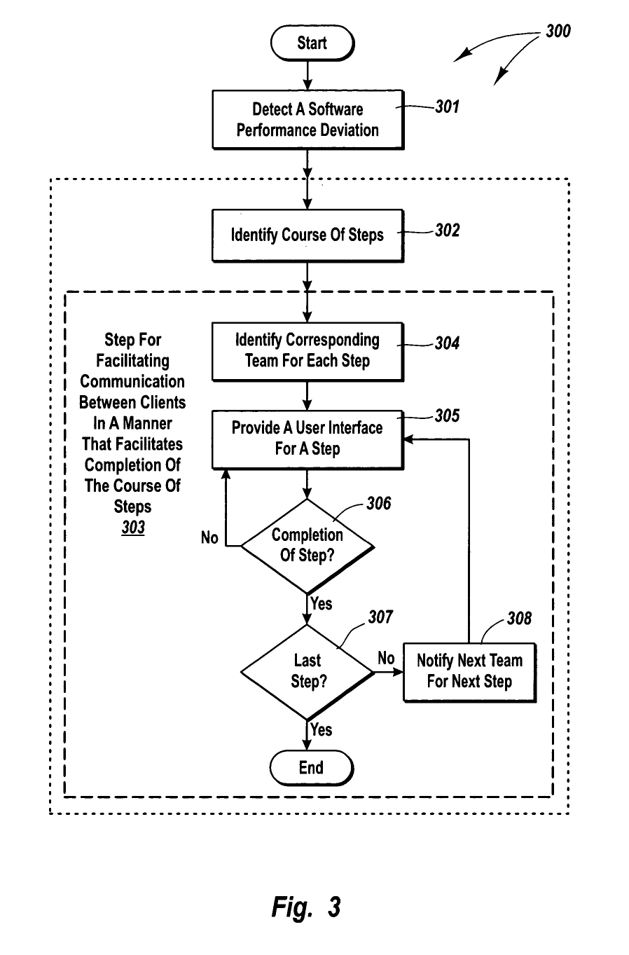

FIG. 3 illustrates a flowchart of a method 300 for the server coordinating communication between the clients in a manner that assists in the generation of corrective software that resolves a software performance deviation. As the method 300 may be implemented in the network environment 200, the method 300 of FIG. 3 will now be described with frequent reference to the network environment 200 of FIG. 2.

The method 300 may be initiated when a software performance deviation is detected (act 301). This detection may occur by for example, a user of a software product reporting regarding the software performance deviation. Alternatively, a group internal to or in cooperation with the software developer of the product may also detect the software performance deviation. In any case, the software performance deviation is reported to the server 201.

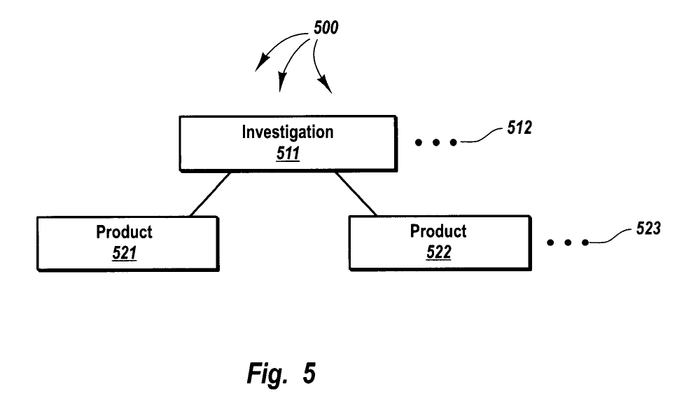

The process involved with resolving a detected software performance deviation will also be referred to herein as an “investigation”. FIG. 5 illustrates a hierarchical structure 500 of an investigation 511 among potentially one or more investigations as represented by the horizontal ellipses 512. The investigation 511 involves one or more products such as, for example, products 521 and 522 among potentially more as represented by the horizontal ellipses 523.

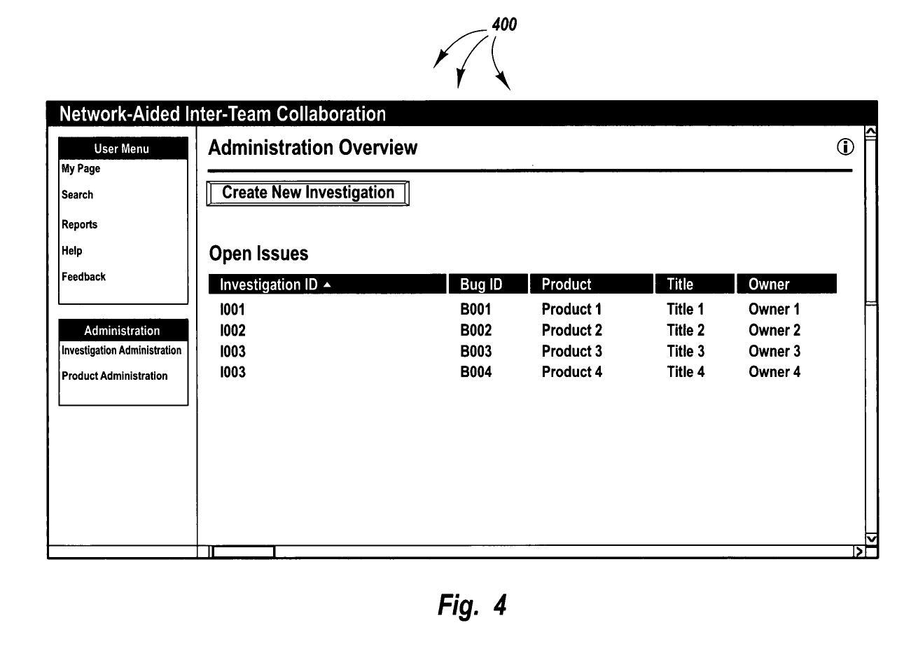

Access privileges may be granted or denied based on this hierarchical structure. For example, individuals may have access to view or edit anything for any investigation, anything for any bug related to a particular product, or anything for a specific bug. FIG. 4 illustrates an investigation administration user interface 400 that may be used to navigate to various investigations, each regarding a software performance deviation. The user interface includes a row for each investigation and bug combination. Each bug corresponds to a particular product and has a specific bug identifier. The user interface may display those investigations, products, or specific bugs for which the user has at least view permission. In this example, the investigation having an identifier 1001 includes a bug having an identifier B001. The investigation having an identifier I002 includes a bug having an identifier B002. The investigation having an identifier I003 includes two bugs having respective identifiers B003 and B004.

As previously mentioned, the software performance deviation may be present in a single product, or may be present in multiple products. The remaining portions of the method 300 (i.e., acts 302, 304, 305 and 308, step 303, and decision blocks 306 and 307) may be performed for each of the one or more affected products.

Specifically, the server 201 identifies a course of steps (act 302) that when successfully completed advances development of corrective software for the software performance deviation. The course of steps may be the same regardless of the investigation or product, although this is not required. The course of steps may be identified by mere virtue of the fact that there is a default course of steps. In another embodiment, the course of steps may be a function of the investigation type (e.g., security related) and product. Regardless, the course of steps requires cooperation between at least two teams.

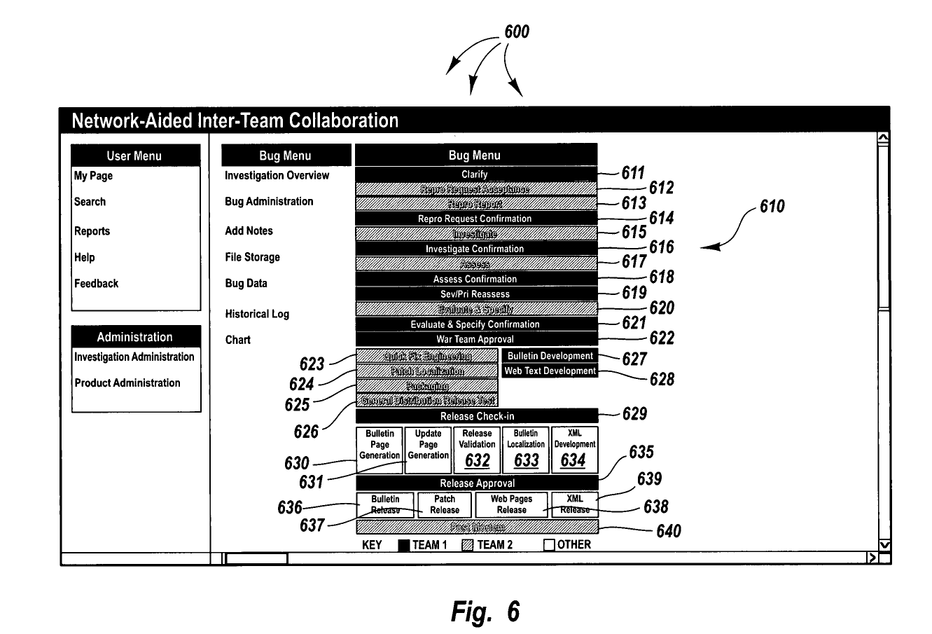

FIG. 6 illustrates a user interface 600 that summarizes a course of steps 610 involved with advancing the generation of corrective software. This user interface 600 may be displayed to those having view permissions for the corresponding product or bug. The user interface 600 may be arrived at by selecting a corresponding row of the user interface 400. The course of steps 610 includes steps 611 through 640. Some of the steps (e.g., steps 611 through 622, 629, 635 and 640) are in series while other steps (e.g., steps 623 through 628, 630 through 634 and 636 through 639) are in parallel. Each parallel branch in the process flow may likewise include serial process flows. For example, steps 623 through 626 represent serial steps within a parallel branch of the overall process flow. In addition, although not shown, each parallel branch of the overall process flow may also include their own parallel process flows. The exact process involved with each step is not important to the principles of the present invention. Any given enterprise may choose different steps and course of steps as is appropriate for that enterprise. The course of steps will depend largely on the specifics of how the enterprise is structured and what teams are available.

The server 201 then performs a functional, result-oriented step for facilitating communication between the clients in manner that facilitates completion of the course of steps (step 303). This step may include any corresponding acts for accomplishing this result. However, in the illustrated embodiment, the step 303 includes corresponding acts 304 through 308.

Specifically, the server identifies a corresponding team of one or more people responsible for proper implementation of the step (act 304) for each of the steps in the course of steps. For example, referring to the user interface 600 of FIG. 6, there are at least three teams involved with the course of steps; represented generically as team 1, team 2, and with any other team being represented generically as “other”. The shading of the boxes representing each step visually identifies the appropriate team responsible for that step. For example, team 1 is responsible for steps 611, 614, 616, 618, 619, 621, 622, 627, 628, 629 and 635. Team 2 is responsible for steps 612, 613, 615, 617, 620, 623 through 626 and 640. Other teams are responsible for steps 630 through 634 and 636 through 639. Each of the steps that correspond to the “other” teams is performed by one of the other teams.

Returning back to FIG. 3, the loop represented by acts 305 through 308 is repeated for each step in the course of steps. Specifically, the server provides a user interface that at least a representative of the corresponding team may access to complete the step (act 305). In one embodiment, some or even all of the team members are allowed access to the user interface. The user interface access may be browser-based. The team members that have access to the user interface may use the browser to navigate to a web page hosted by the server 201. In FIG. 2, the client associated with the representative for each team is represented by a triangle, whereas the clients associated with the other members are represented by rectangles. Although only one representative is shown for each team in FIG. 2, each team may include multiple representatives.

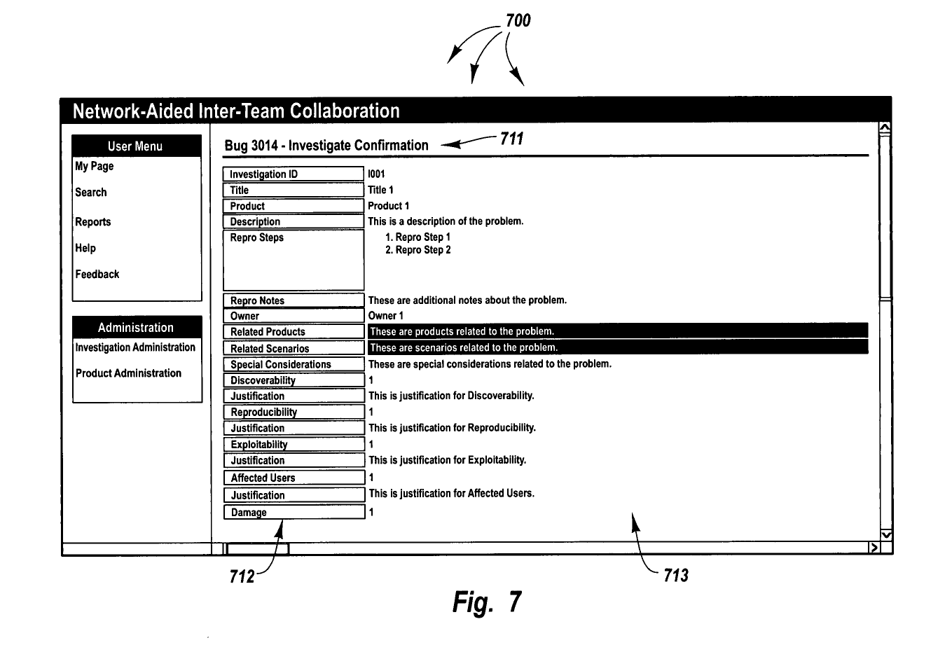

For example, suppose that progress is currently at step 616 (i.e., Investigate Confirmation) in the course of events 610 of FIG. 6, act 305 may involve providing a user interface 700 as represented in FIG. 7 to an authorized team member. The user interface 700 may include any reporting or interactive structure that facilitates accomplishment of the step. Such structure may include any elements that are commonly available for web pages such as radio buttons, text boxes, pull-down menus, static information, previously entered information, or the like. The web page may be dynamically created based on application state information that results from previous steps in the course of steps. In the illustrated embodiment, the user interface 700 includes a title 711 that identifies the associated step, and fields 712 that each identify a field type for a corresponding one of value fields 713.

If the step is not yet completed (NO in decision block 306), the user interface continues to be made available to the authorized team members (act 305). However, if the step is completed (YES in decision block 306), then the method 300 ends if there are no further steps (YES in decision block 307). In this case, however, since the course of events is currently at step 616 in FIG. 6, there are further steps (NO in decision block 307).

In that case, the server causes at least the representative (or some or even all) of the team associated with the next step to be automatically notified upon the completion of the previous step (act 308). If the team for both of these steps is the same, then the notification may be an internal notification to the user. If the team for the next step is different, then the notification may be, for example, an e-mail notification with an embedded hyperlink that allows the authorized associated team for the next step to select the link and access a user interface for the next step.

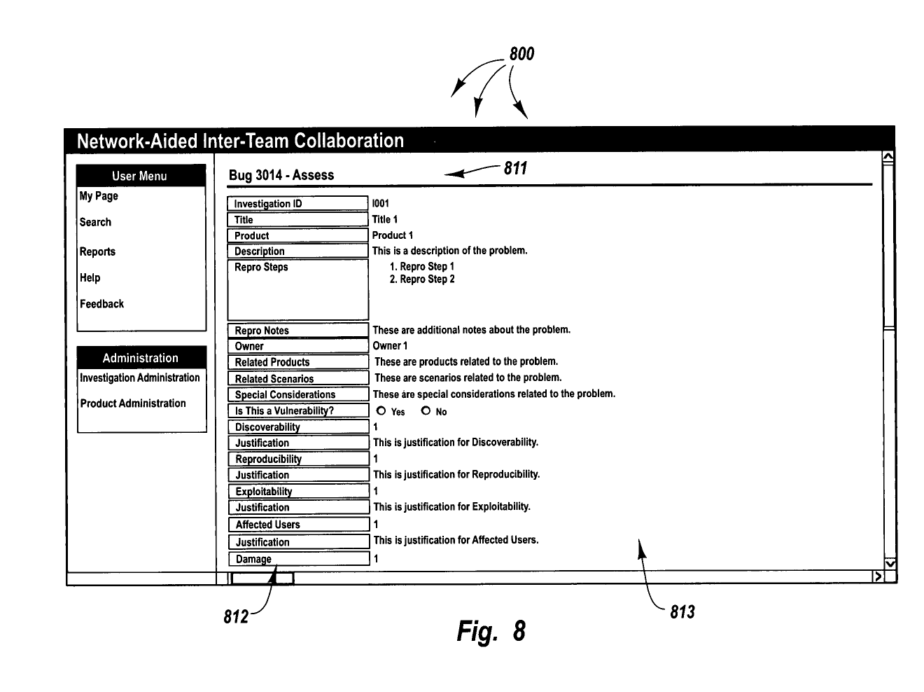

At this stage, the method returns to act 305 where the authorized team member for the next step is provided with a user interface. For example, FIG. 8 illustrates a user interface 800, which includes a title field 811, value type fields 812 and value fields 813. The user interface 800 corresponds to the assess step (i.e., step 617 of FIG. 6). Once again, the user interface 800 includes any structure that presents information and interfaces with the user in a manner that facilitates accomplishment of the step. The precise content of such user interfaces is not important to the principles of the present invention, and will vary according to the structure and preferences of the enterprise implementing the course of steps. In the example user interface of FIGS. 7 and 8, the value fields may be static or editable depending on the step. For example, value fields 713 in the user interface 700 of FIG. 7 are not editable and the highlighting indicates the information the authorized team member is to confirm in the step. However, the Is This a Vulnerability field in value fields 813 in the user interface 800 of FIG. 8 is editable and requires the authorized team member to make a selection. After selecting, the interface will reveal more fields requiring information relevant to that particular selection.

The server 201 may cause the notification from one team to another in several alternative ways. In a first alternative, the server notifies at least the representative of the first team of a network address (e.g., an e-mail address) of at least the representative of the second team. Then, the client associated with that first team's representative then automatically sends the e-mail upon the completion of the previous step. In a second alternative, the server 201 receives notification from the first team that the previous step is completed. Then, the server 201 automatically notifies at least the representative of the second team in response. In this description an in the claims, “automatically” means without requiring concurrent user intervention.

Optionally, each team associated in a step may reject the work of a previous step and thereby return the progress of the course of events to a previous step, with appropriate notification to the team responsible for the previous step. In that case, act 308 may involve notifying a previous team in the course of steps, where the loop then returns to that previous step.

Returning once again to FIG. 6, note that some of the steps are in series and some are in parallel. Accordingly, the course of steps may lead to expansive branching operation when the completion of one step leads to the initiation of multiple parallel steps. For example, when step 622 is complete, parallel steps 623 and 627 are initiated. In that case, the teams associated with steps 623 and 627 are notified once the step 622 is complete. In a corresponding contractive merging operation, one step is only initiated upon the completion of multiple parallel operations. For example, step 629 is not initiated until steps 626 and 628 are both complete.

The process is repeated (acts 305 through 308 of FIG. 8 continue to loop) until all of the steps in the course of steps are complete, with each different team being notified appropriately and given access to the appropriate user interface at the appropriate progress points in the course of events. Accordingly, efficient inter-team collaborative resolution of a software performance deviation may be reached.

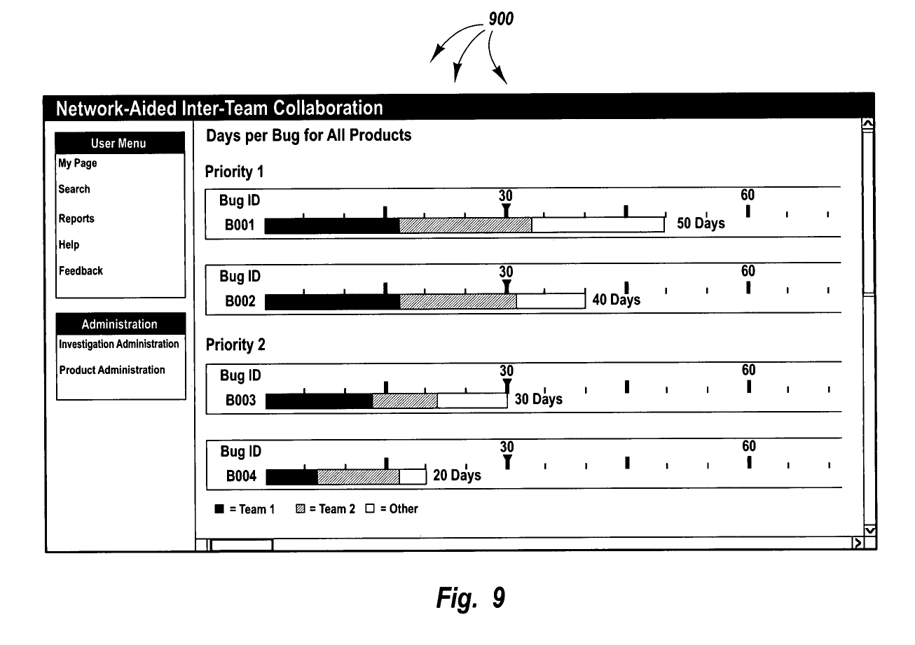

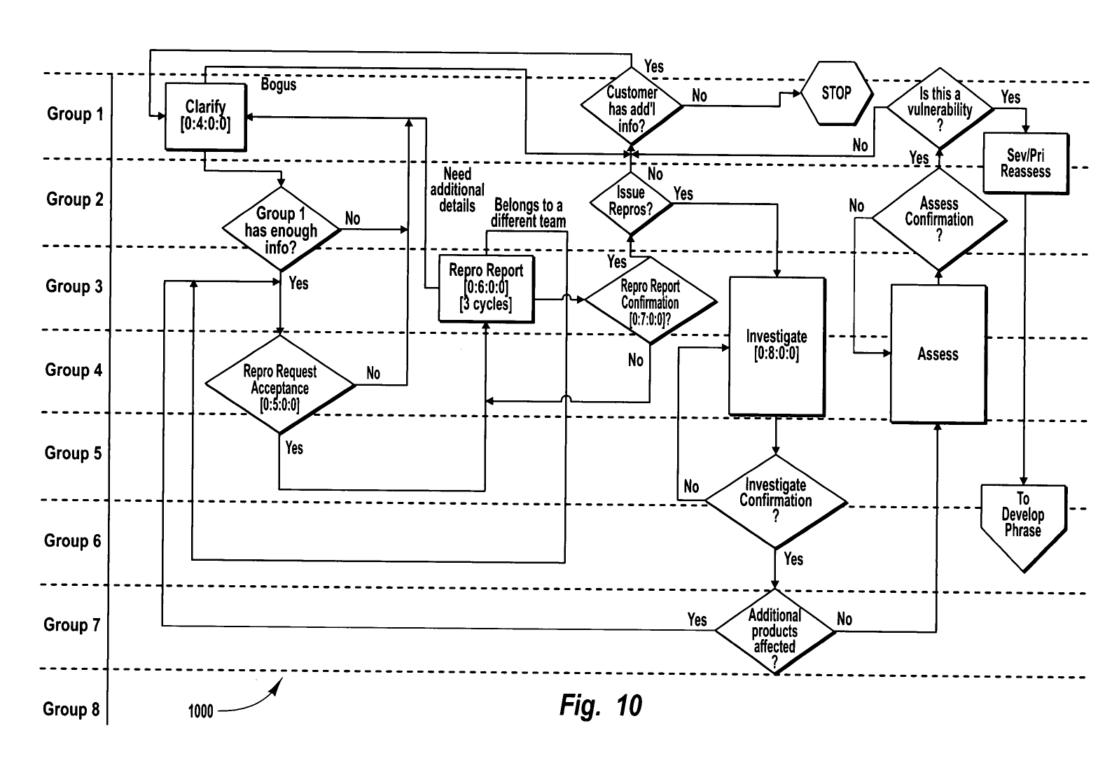

The server 201 may also provide a user interface to allow for user-friendly visual representations of how the course of steps is progressing in accordance with a time budget. FIG. 9 illustrates a user interface 900 illustrates one such interface. The user interface 900 may show progress on all investigations for which the user has view privileges. Other user interfaces such as the user interface 1000 of FIG. 10 illustrate a flowchart representation of how the steps are progressing. The flowchart may be updated in real-time or with some delay. Each step in the flowchart has a color or shading that represents whether the step has been completed, whether the step is in progress, or whether the step is yet to be initiated.

Section III—General Embodiment Related to Inter-Team Collaborative Processes

FIGS. 2 through 10 have been described with respect to a mechanism that facilitates cooperative inter-team communication for the purpose of generating corrective software for software performance deviations. However, one of ordinary skill in the art will recognize, after having reviewed this description, that the principles of the present invention may apply to similar mechanisms that facilitate cooperative inter-team communication for accomplishing any purpose.

The difference would be that instead of detecting a software performance deviation, some other need is detected. The identified course of steps, and the user interface for those steps, would be tailored towards advancing progress towards meeting that specific need, rather than just the software performance deviation. Furthermore, the teams responsible for advancing each step in the course of steps may be different than those responsible for steps related to generating corrective software. In all other respects, however, the method 300 of FIG. 3 may be the same. Accordingly, a mechanism has been described that facilitates inter-team cooperation in progressing through a course of steps that leads to the fulfillment of any need.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed and desired secured by United States Letters Patent is:

1. In a network environment comprising a server computing system network connectable to a plurality of client computing systems, a method for the server computing system coordinating communication between the plurality of client computing systems in a manner that assists in inter-team cooperation for accomplishing a collaborative goal, the method comprising the following:
an act of identifying a course of steps that when successfully completed advances the collaborative goal, the course of steps requiring cooperation between at least two teams of one or more users of the plurality of client computing systems;
for each of the plurality of steps in the course of steps, an act of identifying a corresponding team of one or more people responsible for proper implementation of the step, the course of steps including at least a previous step that corresponds to a first team, and a subsequent step that corresponds to a second team that is at least partially different than the first team;
for the previous step in the course of steps, an act of providing a first user interface that at least a representative of the first team may access to complete the previous step;
an act of causing at least a representative of the second team to be automatically notified upon the completion of the previous step; and
after the act of at least the representative of the second team being automatically notified, an act of providing a second user interface that at least the representative of the second team may access to complete the subsequent step.

2. A method in accordance with claim 1, wherein at least some of the steps in the course of steps are in parallel.

3. A method in accordance with claim 2, wherein the subsequent step is a first subsequent step in parallel with a second subsequent step, the method further comprising the following:
an act of causing at least a representative of a team corresponding to the second subsequent step to be automatically notified upon the completion of the previous step; and
after the act of causing at least a representative of a team corresponding to the second subsequent step to be automatically notified, an act of providing a third user interface that at least the representative of the team corresponding to the second subsequent step may access to complete the second subsequent step.

4. A method in accordance with claim 3, wherein the team that corresponds to the second subsequent step is the same as the second team.

5. A method in accordance with claim 3, wherein the team that corresponds to the second subsequent step is at least partially different than the second team.

6. A method in accordance with claim 5, wherein the team that corresponds to the second subsequent step is the same as the first team.

7. A method in accordance with claim 5, wherein the team that corresponds to the second subsequent step is at least partially different than the first team.

8. A method in accordance with claim 2, wherein the previous step is a first previous step in parallel with a second previous step, the method further comprising the following:
for the second previous step in the course of steps, an act of providing a third user interface that at least a representative of a team that corresponds to the second previous step may access to complete the previous step, wherein the act of causing at least a representative of the second team to be automatically notified upon the completion of the previous step comprises an act of causing at least the representative of the second team to be automatically notified upon the completion of both the first and second previous steps.

9. A method in accordance with claim 8, wherein the team that corresponds to the second previous step is the same as the first team.

10. A method in accordance with claim 8, wherein the team that corresponds to the second previous step is at least partially different than the first team.

11. A method in accordance with claim 10, wherein the team that corresponds to the second previous step is the same as the second team.

12. A method in accordance with claim 10, wherein the team that corresponds to the second previous step is at least partially different than the second team.

13. A method in accordance with claim 1, wherein the act of causing at least a representative of the second team to be automatically notified upon the completion of the previous step comprises the following:
an act of causing at least the representative of the second team to automatically receive an e-mail notification upon the completion of the previous step.

14. A method in accordance with claim 1, wherein the act of causing at least a representative of the second team to be automatically notified upon the completion of the previous step comprises the following:
an act of causing some, but not all, of the second team to be automatically notified upon the completion of the previous step.

15. A method in accordance with claim 1, wherein the act of causing at least a representative of the second team to be automatically notified upon the completion of the previous step comprises the following:
an act of causing all of the second team to be automatically notified upon the completion of the previous step.

16. A method in accordance with claim 1, wherein the first user interface may be accessed by all of the first team.

17. A method in accordance with claim 16, wherein the second user interface may be accessed by all of the second team.

18. A method in accordance with claim 1, wherein the second user interface may be accessed by all of the second team.

19. A method in accordance with claim 1, wherein the product is a first product and the software performance deviation is in a plurality of products including the first product.

20. A method in accordance with claim 1, wherein the act of causing at least a representative of the second team to be automatically notified upon the completion of the previous step comprises the following:
an act notifying at least the representative of the first team of a network address of at least the representative of the second team, wherein at least the representative of the second team is automatically notified directly by the first team upon the completion of the previous step.

21. A method in accordance with claim 1, wherein the act of causing at least a representative of the second team to be automatically notified upon the completion of the previous step comprises the following:
an act of receiving notification from the first team that the previous step is completed; and
an act of automatically notifying at least the representative of the second team in response to the act of receiving notification.

22. A computer program product for use in a network environment comprising a server computing system network connectable to a plurality of client computing systems, the computer program product for implementing a method for the server computing system coordinating communication between the plurality of client computing systems in a manner that assists in inter-team cooperation for accomplishing a collaborative goal, the computer program product comprising one or more computer-readable media having thereon computer-executable instructions that, when executed by one or more processors at the server computing system, cause the server computing system to perform the following:
an act of identifying a course of steps that when successfully completed advances the collaborative goal, the course of steps requiring cooperation between at least two teams of one or more users of the plurality of client computing systems;
for each of the plurality of steps in the course of steps, an act of identifying a corresponding team of one or more people responsible for proper implementation of the step, the course of steps including at least a previous step that corresponds to a first team, and a subsequent step that corresponds to a second team that is at least partially different than the first team;
for the previous step in the course of steps, an act of providing a first user interface that at least a representative of the first team may access to complete the previous step;
an act of causing at least a representative of the second team to be automatically notified upon the completion of the previous step; and
after the act of at least the representative of the second team being automatically notified, an act of providing a second user interface that at least the representative of the second team may access to complete the subsequent step.

23. A computer program product in accordance with claim 22, wherein the one or more computer-readable media are physical media.

24. A computer program product in accordance with claim 23, wherein the physical media is system memory.

25. A computer program product in accordance with claim 23, wherein the physical media is persistent memory.

26. In a network environment comprising a server computing system network connectable to a plurality of client computing systems, a method for the server computing system coordinating communication between the plurality of client computing systems in a manner that assists in the generation of corrective software that resolves a software performance deviation, the method comprising the following:
an act of identifying a course of steps that when successfully completed advances development of corrective software for a software performance deviation in a product, the course of steps requiring cooperation between at least two teams of one or more users of the plurality of client computing systems;
for each of the plurality of steps in the course of steps, an act of identifying a corresponding team of one or more people responsible for proper implementation of the step, the course of steps including at least a previous step that corresponds to a first team, and a subsequent step that corresponds to a second team that is at least partially different than the first team;
for the previous step in the course of steps, an act of providing a first user interface that at least a representative of the first team may access to complete the previous step;
an act of causing at least a representative of the second team to be automatically notified upon the completion of the previous step; and
after the act of at least the representative of the second team being automatically notified, an act of providing a second user interface that at least the representative of the second team may access to complete the subsequent step.

27. A method in accordance with claim 26, further comprising the following:
an act of detecting a software performance deviation in the product.

28. A method in accordance with claim 26, wherein at least some of the steps in the course of steps are in parallel.

29. A method in accordance with claim 28, wherein the subsequent step is a first subsequent step in parallel with a second subsequent step, the method further comprising the following:
an act of causing at least a representative of a team corresponding to the second subsequent step to be automatically notified upon the completion of the previous step; and
after the act of causing at least a representative of a team corresponding to the second subsequent step to be automatically notified, an act of providing a third user interface that at least the representative of the team corresponding to the second subsequent step may access to complete the second subsequent step.

30. A method in accordance with claim 29, wherein the team that corresponds to the second subsequent step is the same as the second team.

31. A method in accordance with claim 29, wherein the team that corresponds to the second subsequent step is at least partially different than the second team.

32. A method in accordance with claim 31, wherein the team that corresponds to the second subsequent step is the same as the first team.

33. A method in accordance with claim 31, wherein the team that corresponds to the second subsequent step is at least partially different than the first team.

34. A method in accordance with claim 28, wherein the previous step is a first previous step in parallel with a second previous step, the method further comprising the following:
for the second previous step in the course of steps, an act of providing a third user interface that at least a representative of a team that corresponds to the second previous step may access to complete the previous step, wherein the act of causing at least a representative of the second team to be automatically notified upon the completion of the previous step comprises an act of causing at least the representative of the second team to be automatically notified upon the completion of both the first and second previous steps.

35. A method in accordance with claim 34, wherein the team that corresponds to the second previous step is the same as the first team.

36. A method in accordance with claim 34, wherein the team that corresponds to the second previous step is at least partially different than the first team.

37. A method in accordance with claim 36, wherein the team that corresponds to the second previous step is the same as the second team.

38. A method in accordance with claim 36, wherein the team that corresponds to the second previous step is at least partially different than the second team.

39. A method in accordance with claim 26, wherein the act of causing at least a representative of the second team to be automatically notified upon the completion of the previous step comprises the following:
an act of causing at least the representative of the second team to automatically receive an e-mail notification upon the completion of the previous step.

40. A method in accordance with claim 26, wherein the act of causing at least a representative of the second team to be automatically notified upon the completion of the previous step comprises the following:
an act of causing some, but not all, of the second team to be automatically notified upon the completion of the previous step.

41. A method in accordance with claim 26, wherein the act of causing at least a representative of the second team to be automatically notified upon the completion of the previous step comprises the following:
an act of causing all of the second team to be automatically notified upon the completion of the previous step.

42. A method in accordance with claim 26, wherein the first user interface may be accessed by all of the first team.

43. A method in accordance with claim 42, wherein the second user interface may be accessed by all of the second team.

44. A method in accordance with claim 26, wherein the second user interface may be accessed by all of the second team.

45. A method in accordance with claim 26, wherein the product is a first product and the software performance deviation is in a plurality of products including the first product.

46. A method in accordance with claim 26, wherein the act of causing at least a representative of the second team to be automatically notified upon the completion of the previous step comprises the following:
an act notifying at least the representative of the first team of a network address of at least the representative of the second team, wherein at least the representative of the second team is automatically notified directly by the first team upon the completion of the previous step.

47. A method in accordance with claim 26, wherein the act of causing at least a representative of the second team to be automatically notified upon the completion of the previous step comprises the following:
an act of receiving notification from the first team that the previous step is completed; and
an act of automatically notifying at least the representative of the second team in response to the act of receiving notification.

48. A computer program product for use in a network environment that comprises a server computing system network connectable to a plurality of client computing systems, the computer program product for implementing a method for the server computing system coordinating communication between the plurality of client computing systems in a manner that assists in the generation of corrective software that resolves a software performance deviation, the computer program product comprising one or more computer-readable media having thereon computer-executable instructions that, when executed by one or more processors at the server computing system, cause the server computing system to implement the method, the method comprising the following:
an act of identifying a course of steps that when successfully completed advances development of corrective software for a software performance deviation in a product, the course of steps requiring cooperation between at least two teams of one or more users of the plurality of client computing systems;
for each of the plurality of steps in the course of steps, an act of identifying a corresponding team of one or more people responsible for proper implementation of the step, the course of steps including at least a previous step that corresponds to a first team, and a subsequent step that corresponds to a second team that is at least partially different than the first team;
for the previous step in the course of steps, an act of providing a first user interface that at least a representative of the first team may access to complete the previous step;
an act of causing at least a representative of the second team to be automatically notified upon the completion of the previous step; and
after the act of at least the representative of the second team being automatically notified, an act of providing a second user interface that at least the representative of the second team may access to complete the subsequent step.

49. A computer program product in accordance with claim 48, wherein the one or more computer-readable media are physical media.

50. A computer program product in accordance with claim 49, wherein the physical media is system memory.

51. A computer program product in accordance with claim 49, wherein the physical media is persistent memory.

52. A computer program product in accordance with claim 48, wherein the one or more computer-readable media further have thereon computer-executable instructions that, when executed by the one or more processors, further cause the computing system to perform the following:
an act of detecting a software performance deviation in the product.

53. A computer program product in accordance with claim 48, wherein the subsequent step is a first subsequent step in parallel with a second subsequent step, the one or more computer-readable media further having thereon computer-executable instructions that, when executed by the one or more processors, cause the server computing system to perform the following:
an act of causing at least a representative of a team corresponding to the second subsequent step to be automatically notified upon the completion of the previous step; and
after the act of causing at least a representative of a team corresponding to the second subsequent step to be automatically notified, an act of providing a third user interface that at least the representative of the team corresponding to the second subsequent step may access to complete the second subsequent step.

54. A computer program product in accordance with claim 48, wherein the previous step is a first previous step in parallel with a second previous step, the one or more computer-readable media further having thereon computer-executable instructions that, when executed by the one or more processors, cause the server computing system to perform the following:
for the second previous step in the course of steps, an act of providing a third user interface that at least a representative of a team that corresponds to the second previous step may access to complete the previous step, wherein the act of causing at least a representative of the second team to be automatically notified upon the completion of the previous step comprises an act of causing at least the representative of the second team to be automatically notified upon the completion of both the first and second previous steps.

55. A computer program product in accordance with claim 48, wherein the computer-executable instructions for performing the act of causing at least a representative of the second team to be automatically notified upon the completion of the previous step comprise computer-executable instructions that, when executed by the one or more processors, cause the server computing system to perform the following:
an act of causing at least the representative of the second team to automatically receive an e-mail notification upon the completion of the previous step.

56. A computer program product in accordance with claim 48, wherein the act of causing at least a representative of the second team to be automatically notified upon the completion of the previous step comprise computer-executable instructions that, when executed by the one or more processors, cause the server computing system to perform the following:
an act of causing some, but not all, of the second team to be automatically notified upon the completion of the previous step.

57. A computer program product in accordance with claim 48, wherein the act of causing at least a representative of the second team to be automatically notified upon the completion of the previous step comprise computer-executable instructions that, when executed by the one or more processors, cause the server computing system to perform the following:
an act of causing all of the second team to be automatically notified upon the completion of the previous step.

58. A computer program product in accordance with claim 48, wherein the act of causing at least a representative of the second team to be automatically notified upon the completion of the previous step comprise computer-executable instructions that, when executed by the one or more processors, cause the server computing system to perform the following:
an act notifying at least the representative of the first team of a network address of at least the representative of the second team, wherein at least the representative of the second team is automatically notified directly by the first team upon the completion of the previous step.

59. A computer program product in accordance with claim 48, wherein the act of causing at least a representative of the second team to be automatically notified upon the completion of the previous step comprise computer-executable instructions that, when executed by the one or more processors, cause the server computing system to perform the following:
an act of receiving notification from the first team that the previous step is completed; and
an act of automatically notifying at least the representative of the second team in response to the act of receiving notification.

60. In a network environment comprising a server computing system network connectable to a plurality of client computing systems, a method for the server computing system coordinating communication between the plurality of client computing systems in a manner that assists in the generation of corrective software that resolves a software performance deviation, the method comprising the following:
an act of identifying a course of steps that when successfully completed advances development of corrective software for a software performance deviation in a product, the course of steps requiring cooperation between at least two teams of one or more users of the plurality of client computing systems; and
a step for facilitating communication between the plurality of client computing systems in manner that facilitates completion of the course of steps.

61. A method in accordance with claim 60, wherein the step for facilitating communication between the plurality of client computing systems in a manner that facilitates completion of the course of steps comprises the following:
for each of the plurality of steps in the course of steps, an act of identifying a corresponding team of one or more people responsible for proper implementation of the step, the course of steps including at least a previous step that corresponds to a first team, and a subsequent step that corresponds to a second team that is at least partially different than the first team;
for the previous step in the course of steps, an act of providing a first user interface that at least a representative of the first team may access to complete the previous step;
an act of causing at least a representative of the second team to be automatically notified upon the completion of the previous step; and
after the act of at least the representative of the second team being automatically notified, an act of providing a second user interface that at least the representative of the second team may access to complete the subsequent step.

62. A method in accordance with claim 61, further comprising the following:
an act of detecting a software performance deviation in the product.

63. A method in accordance with claim 60, further comprising the following:
an act of detecting a software performance deviation in the product.
